(19) United States
(12) Patent Application Publication
(10) Pub. No.: US 2005/0054754 A1
(43) Pub. Date: Mar. 10, 2005

(54) Rocket motor insulation containing coated hydrophilic fillers

(75) Inventors: Jun-Ling Fan, Tao-Yuan (TW); Wen-Dar Ho, Tao-Yuan (TW)

Correspondence Address: BACON & THOMAS, PLLC, 625 SLATERS LANE, FOURTH FLOOR, ALEXANDRIA, VA, 22314, US

(73) Assignee: Chung-Shan Institute of Science & Technology, Tao-Yuan (TW)

(21) Appl. No.: 10/657,131

(22) Filed: Sep. 9, 2003

(51) Int. Cl. C08L 1/00

(52) U.S. Cl. 524/1

(57) ABSTRACT

A rocket motor insulation is formed of a solid EPDM rubber, a liquid EPDM rubber, an inorganic hydrophilic filler, and polyaramide fiber in place of asbestos of the conventional insulation. The hydrophilic filler takes the form of powder. The fine particles of the filler powder are encapsulated with a rubber material. The encapsulated particles of the filler are provided with protection against interference by moisture contents of other ingredients of a compounding recipe, relative humidity of a processing environment, and a shearing stress brought about in the course of preparation. The vulcanized end product of the insulation has an excellent physical property of ablative resistance.

### FIELD OF THE INVENTION

The present invention relates to a rubber composition which is used as a rocket motor insulation. The process stability and the storage stability of the rocket motor insulation can be enhanced by coating the hydrophilic fillers contained in the rubber composition.

### BACKGROUND OF THE INVENTION

The propellant of a solid rocket motor is made up of various high energy fuels, oxidizer, and rubber materials. In the course of combustion of the propellant, a large amount of gas is produced, along with a release of extremely high heat energy which is accumulated in the limited space within the rocket motor to result in a high temperature ranging from 2400° C. to 3700° C. Such a high temperature poses a safety hazard to the rocket motor case. For this reason, the rocket motor of missiles of all types is provided with an insulating and flame retardant device to safeguard the motor.

The ammonium compound is used as a component in the rocket motor insulation and is ablated to yield ammonia (NH₃) capable of bringing about a fire extinguishing effect on the rocket motor, thereby resulting in enhancement of ablative resistance of the insulation. The rocket motor insulation of the MK-52 Mod 2 of Sparrow missile makes use of ammonium sulfate ((NH₄)₂SO₄, 33.5 phr) as a filler. U.S. Pat. No. 5,821,284 (1998) discloses a synergistic effect of ammonium sulfate and antimony oxide on the making of a rocket motor insulation based on an ethylene propylene diene monomer rubber (abbreviated as hereinafter EPDM) and polyaramide fiber. As a result, the ablative resistance of the insulation is effectively enhanced. The ammonium sulfate is a water-soluble inorganic salt. As the ammonium sulfate is used to make the insulation, a portion of which will be located on the surface of the rubber material. When the insulation is exposed to a high atmospheric moisture, the exposed ammonium sulfate will takes up the moisture and a solution thereof will be formed, which causes de-bonding of the laminated insulation structure and difficult in adhesion between insulation layers. A cured insulation made thereof can be also adversely affected to endanger a rocket in operation.

### SUMMARY OF THE INVENTION

The primary objective of the present invention is to provide an effective material and method for coating hydrophilic fillers which are contained in an insulation formulation. The coating material is resistant to the shearing stress between the machine and the coated fillers in the process of making the insulation. Ammonium sulfate for example is a hydrophilic filler and is completely encapsulated by a rubber material having an elasticity. The encapsulated ammonium sulfate is prevented from taking up air moisture, so as to stabilize the physical properties of the insulation.

It is another objective of the present invention to provide a method of encapsulating hydrophilic fillers contained in a rocket motor insulation. The encapsulated fillers are prevented from taking up moisture during the process of making the insulation and in an environment in which the insulation is used, and thus stabilize the physical properties of the insulation.

The present invention provides a rocket motor insulation which has a low specific gravity and an excellent ablative resistance. In addition, the rocket motor insulation does not produce the toxic gas upon being ablated. The insulation contain EPDM rubber and polyaramide fiber as a major portion, with aluminum hydroxide (Al(OH)₃) or magnesium hydroxide (Mg(OH)₂), silicon dioxide (SiO₂), ammonium sulfate, and antimony oxide (Sb₂O₃) serving as ablative fillers.

The present invention makes use of microencapsulation to enclose a hydrophilic filler, such as ammonium sulfate, by a flexible polyurethane rubber material. In another words, the hydrophilic filler is made to exist in the form of a capsule, so as to unable to take up moisture. As a result, the performance of the insulation is stabilized. In addition, the filler particles are enclosed in the capsule made of the polyurethane rubber material and are therefore immune from the destruction which is caused by a shearing force brought about in the course of milling and compounding.

The insulation of the present invention contains polyaramide fiber in place of the conventional asbestos fiber which poses an environmental hazard. The polyaramide fiber is an organic component and is capable of complete carbonization upon being ablated.

The insulation of the present invention contains liquid EPDM rubber to facilitate the adjusting of the flexibility of the insulation. The insulation of the present invention can be easily applied to the inner wall of a rocket motor case by the manual lay-up or inflatable mandrel technique. On the contrary, the conventional rocket motor insulation contains an excess amount of polyaramide fiber (30-50 parts by weight per hundred parts by weight of total EPDM rubber (abbreviated as phr hereinafter)), which tends to make the insulation rigid. As a result, the conventional rocket motor insulation calls for the use of an expensive precision process machine.

The recipe of the rubber-type rocket motor insulation of the present invention excludes the conventional fillers containing the halogen compound. As a result, the ablation of the insulation of the present invention results in a minimum amount of toxic gas or haze. In another words, the insulation of the present invention is environmentally friendly.

The vulcanized insulation of the present invention has a low specific gravity, a low heat conduction coefficient, an appropriate hardness, and an excellent ablative resistance. The insulation of the present invention is therefore capable of withstanding a high temperature in the range of 2400° C. to 3700° C., which is brought about by the combustion of the rocket propellant. It is therefore readily apparent that the insulation of the present invention serves to safeguard effectively the structural integrity of the rocket motor case.

### DETAILED DESCRIPTION OF THE INVENTION

A suitable process for making a rocket motor insulation of the present invention comprises the steps of:
(A) compounding 50-95 parts by weight of a solid EPDM rubber, 5-50 parts by weight of a liquid EPDM rubber, and 5-50 phr of polyaramide fiber so as to form a mixture, wherein the weight parts of said solid EPDM rubber and said liquid EPDM rubber amount to 100 parts by weight, said EPDM rubber represents ethylene propylene diene monomer rubber, and said phr represents parts by weight per 100 parts by weight of said solid EPDM rubber and said liquid EPDM rubber; and
(B) adding to the compounded mixture of step (A) 5-100 phr of an inorganic filler and 5-50 phr of encapsulated particles of ammonium sulfate powder, and compounding the resulting mixture, wherein said inorganic filler is silicon dioxide, aluminum hydroxide, or magnesium hydroxide.

Preferably, said process further comprises a step (C) in which 0.1-5 phr of sulfur and 0.01-3 phr of a vulcanization accelerator are added to the compounded mixture of step (B), and the resulting mixture is compounded, wherein said vulcanization accelerator is 4,4′-dithiodimorpholine, or N-tert-butyl-2-benzothiazole sulfenamide.

Preferably, the encapsulated particles of said ammonium sulfate powder in step (B) are formed by encapsulating ammonium sulfate powder with a rubber material, the encapsulated particles of said ammonium sulfate powder having a diameter ranging from 50 micron to 80 micron. More preferably, said rubber material is polyurethane.

Preferably, the encapsulated particles of said ammonium sulfate powder are formed by mixing particles of said ammonium sulfate powder with an organic solution of said rubber material by stirring, separating the resulting coated ammonium sulfate powder from the solution, and drying the coated ammonium sulfate powder in a fluidized bed.

The rocket motor insulation of the present invention contains polyaramide fiber in place of the conventional asbestos fiber. The recipe of the present invention includes a plurality of the ablation-resistant fillers, such as aluminum hydroxide (Al(OH)₃) or magnesium hydroxide (Mg(OH)₂), silicon dioxide (SiO₂), ammonium sulfate, and antimony oxide (Sb₂O₃). The recipe of the present invention further includes solid EPDM rubber and liquid EPDM. The solid EPDM rubber is used to facilitate the processing of the insulation by virtue of the fact that the solid EPDM rubber has a low specific gravity, an excellent aging resistance, and a capacity for retaining its flexibility at a low temperature. The addition of the liquid EPDM is intended to facilitate the adjusting of the flexibility of the insulation such that the insulation is made feasible to be applied on the inner wall of the case of a rocket motor. The recipe contains 5-50% of the liquid EPDM by weight of the total EPDM.

According to the G-GTS 1763 Standard, the insulation of the present invention has a specific gravity ranging from 1.140 gr/cm³ to 1.210 gr/cm³; an appropriate hardness (Shore A 82±7); a theraml conductivity of ≦0.245 Kcal/m.h. ° C., in accordance with ASTM D 581 Standard; an excellent ablation resistance of ≧8.20 sec/mm, in accordance with ASTM E 285 Standard; an excellent aging resistance; and a capacity for retaining its flexibility even at a low temperature of minus 50° C. In addition, the toxicity of the gas produced by the ablation of the insulation of the present invention is negligible. The insulation of the present invention is therefore an ideal material to insulate the rocket motor of a new-generation missile.

The basic ingredient of the insulation of the present invention is EPDM rubber, which is subjected to vulcanization at a temperature under 130° C. The vulcanization of the rubber is carried out by colloidal sulfur, which amounts to 0.1 phr-5 phr, by preference 0.5 phr-2.5 phr. The present invention makes use of an accelerator of vulcanization, which is, for example, 4,4′-dithiodimorpholine or N-tert-butyl-2-benzothiazole sulfenamide in a dose ranging from 0.01 phr to 3 phr, preferably 0.5 phr-2 phr.

The polyaramide fiber used in the present invention is preferably in the form of pulp and has a length-diameter ratio of 500. The physical properties of an ideal polyaramide fiber are listed in the following Table 1.

TABLE 1
Required physical properties of Polyaramide fiber

| | |
|---|---|
| Tensile strength (kg/cm²) | 30,000˜40,000 |
| Tensile modulus (kg/cm²) | 7.6 × 10⁸˜1 × 10¹⁰ |
| Elongation (%) | 3˜5 |
| Density (g/cm³) | 1.4˜1.5 |
| Fiber diameter (μm) | 10˜14 |
| Degradation temperature (° C.) | 400˜600 |
| Thermal expansion coefficient (° C.⁻¹) | −2 × 10⁻⁶ |

The pulpy polyaramide fiber of the present invention has a length in the range of 0.5-4.0 mm, most preferably 1-3 mm; and a dose of 5 phr-50 phr, most preferably 10 phr-30 phr.

The recipe of the insulation of the present invention includes the liquid EPDM rubber, which is used as a flexibility modifier, for the purpose of promoting the congregation of the solid fillers, the polyaramide fiber, and the solid EPDM rubber. The liquid EPDM rubber and the solid EPDM rubber are identical in chemical composition but different in molecular weight; nevertheless they are compatible. The liquid EPDM rubber serves as a plasticizer. In the course of the vulcanization, the liquid EPDM rubber and the solid EPDM rubber are catalyzed by sulfur and sulfur-containing accelerator such that they are vulcanized simultaneously. Unlike the conventional rubber insulation, the rubber insulation of the present invention is not susceptible to the plasticizer migration during a storage period of the rocket. The liquid EPDM rubber of the present invention also plays a role of enhancing tack of the green insulation sheet. The tack of the insulation rubber can be further enhanced by a tackifier. The tackifier used in the present invention is a synthetic polyterpene resin in a dose of 1 phr-10 phr, by preference 4 phr-8 phr.

In order to enhance the ablative resistance of the insulation of the present invention, the recipe of the present invention includes a plurality of ablation-resistant fillers, such as aluminum hydroxide (Al(OH)₃) or magnesium hydroxide (Mg(OH)₂), silicon dioxide (SiO₂), ammonium sulfate, and antimony oxide (Sb₂O₃). If aluminum hydroxide or magnesium hydroxide is used alone, it is decomposed to release water molecules in high temperature ablation. The water molecules so released have a cooling effect on the surfaces of the materials making up of the insulation, thereby resulting in improvement of performance of the insulation in terms of the ablation resistance. When antimony oxide (Sb₂O₃), ammonium sulfate and aluminum hydroxide (Al(OH)₃) or magnesium hydroxide (Mg(OH)₂) are combined, a synergistic effect occurs, and thus the ablative resistance of the individual filler is enhanced.

In light of the hydrophilic property of the ammonium sulfate filler, the present invention makes use of microencapsulation, by means of which the particles of the ammonium sulfate filler are enclosed in the microcapsules of a water-repellent material. The water-repellent material used in the present invention is polyurethane. As a result, the hydrophilic capability of the ammonium sulfate filler is effectively undermined. In addition, the polyurethane microcapsules of the present invention serve to provide the particles of the ammonium sulfate filler with protection against a shearing force which is brought about in a milling-compounding process.

It must be noted here that the ammonium sulfate filler of the present invention must be first comminuted so that the filler can be microencapsulated. The comminution of the ammonium sulfate filler is attained by a non-solvent capable of effecting a phase separation of the aqueous solution of the ammonium sulfate and a high-speed stirring. The fine particles of the ammonium sulfate filler have a diameter smaller than 80 micrometer. The aqueous solution of ammonium sulfate is prepared by mixing ammonium sulfate and water in a weight ratio of (0.1-1.0): (0.3-3.0). The non-solvent used in the present invention is a volatile solvent, such as ethyl alcohol or acetone. The non-solvent works to precipitate ammonium sulfate particles and to remove water from the surface of the ammonium sulfate particles. The phase separation is carried out by adding gradually the droplets of the aqueous solution of ammonium sulfate into the non-solvent which is agitated at a high speed. The particle size is dependent on the agitation speed and the shape of the stirrer. A suspension is obtained and then filtered. The particles are rinsed with the non-solvent and then transferred to a microencapsulation solvent. The non-solvent of low boiling point and a minute amount of water are removed by vacuum distillation. The heating temperature ranges from 70° C. to 100° C., depending on the nature of the non-solvent which is used in the microencapsulation.

The present invention makes use of polyurethane as the microencapsulating material, which amounts to 0.1%-10% by weight of ammonium sulfate, depending on the particle size, and preferably 1.6%-8.0%. The polyurethane is obtained by a reaction of polyol, amine chain extender, and polyisocyanate. The amine chain extender is mainly a polyamine which has a functional group number greater than or equal to 2. The polyol used in the present invention is selected from polypropylene glycol (PPG), hydroxy terminated polybutadiene (HTPB), polyoxytetramethylene glycol (POTMG), polytetramethylene glycol (PTMG), polycarpolactonediol, or polyethylene adipatediol. The polyisocyanate is selected from the bifunctional, trifunctional, or polyfunctional isocyanate compounds, such as 2,4-toluene diisocyanate (TDI), m-tetramethylenexylene diisocyanate (TMXDI), 4,4′-diphenemethane diisocyanate (MDI), 4,4′-methylenebis(cyclohexyl) diisocyanate (HMDI), isophorone diisocyanate (IPDI), and hexamethylene diisocyanate (HDI). The amine chain extender used in the present invention includes toluene diamine, ethylene diamine, tetramethylene diamine, hexamethylene diamine, and phenylene diamine. The equivalent ratio of the polyol and the polyisocyanate is 1.0:1.5, by preference 1.0:1.2.

The microencapsulation of the particles of ammonium sulfate comprises two main steps. The first step involves the suspending of the particles in a reaction medium, such as toluene, xylene, paraffin, or ketone. The reaction medium is an organic solvent with a boiling point higher than the water boiling point. The suspension is prepared by mixing 100 g of the particles with 100-300 ml of the reaction medium, preferably 150-250 ml of the reaction medium. Thereafter, the polyol and the chain extender are added into the suspension, which is heated at a temperature ranging from 60° C. to 100° C., preferably 70° C. to 90° C., depending on the nature of the reactant and the rate of the reaction. The reaction system is agitated at a speed ranging from 500 rpm to 1500 rpm. The agitation speed determines the particle size. In general, a low agitation speed results in a greater particle size which in turn results in an uneven encapsulation. The agitation speed must be so controlled that the reaction product is attached to the surface of each particle. Finally, the polyisocyanate is added to the solvent containing the polyol. The polyisocyanate must be first diluted with the same solvent or compatible solvent prior to being added in droplets into the solvent containing the polyol. The dose of the solvent is 0.5-5.0 times as much as the volume of polyisocyanate, preferably 1.0-1.5 times. At the conclusion of the reaction, a mixture is obtained. The solvent is removed from the mixture by vacuum distillation. The mixture is thus pasty.

The second step of the microencapsuation involves the use of a fluidized bed to dry the pasty mixture so as to enable the pasty mixture to take the form of powder. A post-curing of the polymer is simultaneously carried out while drying, and thus the powder product obtained has a good mobility.

The features and the advantages of the present invention will be more readily understood upon a thoughtful deliberation of the following detailed description of the nonrestrictive preferred embodiments of the present invention.

### EXAMPLE 1

A solution was prepared by mixing 300 g of ammonium sulfate with 400 g of water in a first flask with a capacity of 1000 ml. A second 1000 ml flask was used to hold 300 ml of acetone. The acetone was agitated by a mechanical agitator at a speed of 500 rpm. The solution contained in the first flask was slowly poured into the second flask at a rate of 60 ml per minute. The agitation in the second flask had been kept on for 3 minutes after the addition was completed. As the powder of ammonium sulfate was completely precipitated, the powder was collected by filtration. The ammonium sulfate powder so collected was added to a flask containing 500 ml of acetone. The suspension in the flask was agitated at a speed of 500 rpm for 3 minutes for removing water from the ammonium sulfate powder, which was then collected by filtration. The removal of a minute amount of water and acetone from the ammonium sulfate powder was attained by a vacuum distillation process in which 300 g of the ammonium sulfate powder and 500 ml of xylene was mixed in a flask and heated at 90 degrees in Celsius.

The ammonium sulfate powder suspension in xylene was mixed with 7 g of polyester polyol and 0.21 g of toluene diamine. The mixture was stirred at 700 rpm and was heated at 80 degrees in Celsius. A hexamethylene diisocyanate (HDI) solution (containing 1.0 g of HDI in 5 ml of xylene) was added to the mixture dropwise within 10 minutes. In the wake of 30-minute reaction and agitation, a sticky block was obtained as a result of the vacuum removal of xylene. The block has a weight of 320 g or so. The block was air dried in a fluidized bed at a speed of 5-10 meters per second for a further removal of xylene, thereby resulting in production of 260 g of ammonium sulfate powder. The powder was baked at 80 degrees in Celsius for about 14 hours to enable the powder to have an excellent mobility.

### EXAMPLE 2

In accordance with the ASTM D 5032-90 method, a mixture was prepared by mixing 96 g of glycerin (48 wt %) with 104 g of pure water (52 wt %). The mixture was then transferred to a desiccator with a capacity of 4000 ml. The relative humidity (RH) was kept constantly at 80% within a confined space in said desiccator.

One of two weighting bottles, each having a capacity of 50 ml, was used to contain precisely 20 g of the ammonium sulfate powder obtained in Example 1 described above. The powder contained fine particles with diameter of 80 micron. Other one of the bottles was used to contain precisely 20 g of the unprocessed ammonium sulfate powder with the particle size of 80 micron. A third weighting bottle with a capacity of 50 ml was devoid of anything and was used as a reference experiment. All three bottles were kept in a desiccator containing a mixture solution of glycerin and water in a specific ratio, wherein the relative humidity was kept at 80%. The caps of the weighting bottles were opened, while the cover of the desiccator was securely closed. The desiccator was kept without disturbance at 28° C. for 2 hours, so as to enable the relative humidity in the desiccator to reach an equilibrium.

As soon as the cover of the desiccator was opened up, the caps of the bottles were promptly closed before removing the bottles from the desiccator.

The outer surface of the bottles was carefully wiped with a tissue paper for removing condensed water. With a precision balance, each of the weighting bottles was weighed in such a way that its weight was indicated by a number with four decimal fractions. Upon completion of the weighing of the bottles, the bottles were returned to the desiccator so that the ammonium sulfate in the bottles began taking up moisture.

The experiment described above was repeated. The experimental data are contained in the following Table 2.

TABLE 2
Comparative results of hydrophilic performance of the processed
ammonium sulfate and the unprocessed ammonium sulfate*

| Time | Unprocessed | Processed | Empty bottle |
|---|---|---|---|
| (hrs) | (g × 10³) | (g × 10³) | (g × 10³) |
| 0 | 0 | 0 | 0 |
| 2 | 9.4 | 2.1 | 3 |
| 4 | 14.3 | 3.6 | 3 |
| 6 | 22.4 | 4.4 | 4 |
| 8 | 43.8 | 5.1 | 4 |
| 24 | 60.3 | 8.9 | 5 |
| 48 | 89.5 | 13.3 | 5 |

*Conditions of hydrophilic performace: 28° C.; 80% RH

According to the data of Table 2, it is readily apparent that the unprocessed ammonium sulfate takes up the air moisture rapidly in an environment with a high humidity. On the contrary, the weight of the processed ammonium sulfate remains relatively stable. The implication is that the hydrophilic performance of a hydrophilic inorganic salt can be significantly deterred by encapsulation.

### EXAMPLE 3

A mastication of 355.9 g (60 parts) of solid EPDM rubber was carried out in a Banbury mixer with a capacity of one liter. The mastication lasted for 20 seconds. The mastication was followed by a compounding process, in which 237.3 g (40 parts) of liquid EPDM and 59.4 g (10 phr) of polyaramide fiber were added to the masticated EPDM rubber. The compounding process lasted for 40 seconds to enable the liquid EPDM to wet the surface of the polyaramide fiber. Meanwhile, the liquid EPDM rubber was blended thoroughly with the solid EPDM rubber. A second compounding process was carried out for 20 seconds by adding 5.9 g (1 phr) of stearic acid. A third compounding process was carried out for 30 seconds by adding 118.7 g (20 phr) of silicon dioxide, and 118.7 g (20 phr) of aluminum hydroxide. A fourth compounding process was carried out for 30 seconds by adding 59.4 g (10 phr) of antimony oxide and 118.7 g (20 phr) of the processed (encapsulated) ammonium sulfate powder (with particle diameter of 80 micron). A fifth compounding process was carried out for 30 seconds by adding 5.9 g (1 phr) of substituted diphenylamine as an anti-oxidant and 41.5 g (6 phr) of synthetic polyterpene resin as a tackifier, as well as 59.4 g (10 phr) of chlorinated wax. A sixth compounding process was carried out for 20 seconds by adding 29.7 g (5 phr) of zinc oxide. The rubber material was discharged to be compounded in a two-roll mill, into which 11.9 g (2 phr) of sulfur and 5.9 g (1 phr) of 4,4′-dithiodimorpholine vulcanization accelerator were added. The compounding lasted for 2 minutes to result in production of the rubber insulation of the present invention.

### EXAMPLES 4-7

The procedures described in Example 3 were repeated, except that formulation was changed to those listed in Table 4. The sequence and durations of the operational procedures are contained in Table 3. As a result, rubber insulations were made from various ratios of the components.

TABLE 3
Operational procedures of Examples 3-7

| Order of addition | Mixing time (second) |
|---|---|
| Rubber mastication | 20 |
| Polyaramide fiber | 40 |
| Ablation-resistant agent | 30 |
| Inorganic fillers | 30 |
| Organic fillers | 30 |
| Sulfur and vulcanization accelerator | 120 |

TABLE 4
Formulations of insulations of the Examples 4-7

| Example | 4 | 5 | 6 | 7 |
|---|---|---|---|---|
| EPDM rubber^{a} | 60 | 60 | 60 | 60 |
| Liquid EPDM rubber^{b} | 40 | 40 | 40 | 40 |
| Stearic acid | 1 | 1 | 1 | 1 |
| Anti-oxidant^{c} | 1 | 1 | 1 | 1 |
| Polyaramide fiber^{d} | 10 | 10 | 20 | 10 |
| Aluminum hydroxide | 20 | 20 | 20 | 20 |
| Silicon dioxid^{e} | 20 | 20 | 20 | 20 |
| Ammonium sulfate | 20 | — | — | — |
| (uncoat) | | | | |
| Ammonium sulfate | — | 10 | 20 | — |
| (coated) | | | | |
| Halogenated fire retardant | — | — | — | 30 |
| agent^{f} | | | | |
| Zinc oxide | 5 | 5 | 5 | 5 |
| tackifier^{g} | 6 | 6 | 6 | 6 |
| Antimony oxide | 10 | 10 | 10 | 10 |
| Chlorinated wax | 10 | 10 | 10 | 10 |
| Sulfur | 2 | 2 | 2 | 2 |
| Vulcanization accelerator | 1 | 1 | 1 | 1 |

^{a}Sumitomo 505A of Sumitomo Co., Japan
^{b}Trilene 65 of Uniroyal chemical Co., USA
^{c}Naugard 445 of Uniroyal Chemical co., USA
^{d}Kevlar pulp of DuPont Co., USA
^{e}Hi-Sil 233T of PPG Co., USA
^{f}Dechloran Plus 25 of Ocidental Chemical Co., USA
^{g}Wingtack 95 of Goodyear and Rubber Co., USA

Experiments

The finished products of Examples 3-7 were processed by a calender and were wound up, with polyethylene film serving as a liner to enable the shipping and the storing of the finished products. The finished products can be cut, laminated, and expanded/vulcanized for use as rocket motor insulations.

The physical properties of the insulation products of Examples 3-7 are contained in Table 5. When the products are processed through a calender, the polyaramide fibers contained in the products are acted on by a shearing force of the calender and oriented in an output direction. The physical properties of the calendered insulator sheet in the parallel and the vertical directions are apparently different.

According to the data contained in Table 5, the insulation of the present invention is flexible enough to enable the lamination of the insulations on an air sac, and the laminated insulation layer to be inflated by an inflatable mandrel technique, thereby causing the insulation layer to be tightly adhered on the inner wall of a rocket motor case. In addition, the insulation of the present invention can also be processed by techniques, such as the manual lay-up, strip winding, and winding on grain, by virtue of the fact that the insulation of the present invention has a sufficient strength.

TABLE 5
Physical properties of the insulation products of Examples 3-7

| Example | | | | |
|---|---|---|---|---|
| 3 | 4 | 5 | 6 | 7 |

Uncured insulator

| | Tensile strength (kg/cm²) | | | | |
|---|---|---|---|---|---|
| Parallel | 13.23 | 13.77 | 12.97 | 17.82 | 13.45 |
| Vertical | 3.42 | 3.47 | 3.20 | 4.21 | 3.78 |
| | Elongation (%) | | | | |
| Parallel | 17.12 | 18.16 | 19.27 | 12.14 | 14.32 |
| Vertical | 30.20 | 32.64 | 32.47 | 30.22 | 32.33 |

Cured insulator
curing condition 120° C./2 hr/30 kg · cm⁻²

| | Tensile strength (kg/cm²) | | | | |
|---|---|---|---|---|---|
| Parallel | 117.16 | 110.03 | 104.21 | 127.22 | 122.71 |
| Vertical | 107.19 | 97.72 | 89.37 | 102.35 | 110.23 |
| | Elongation (%) | | | | |
| Parallel | 33.57 | 34.10 | 37.45 | 30.98 | 29.14 |
| Vertical | 34.99 | 33.32 | 39.42 | 30.40 | 30.25 |
| Hardness (Shore A) | 86.5 | 87 | 86 | 89 | 89 |
| Specific gravity | 1.20 | 1.21 | 1.19 | 1.18 | 1.23 |
| (g/cm³) | | | | | |
| Thermal conductivity | 0.255 | 0.255 | 0.247 | 0.238 | 0.265 |
| (Kcal/mh ° C.) | | | | | |

The finished products of the Examples 3-7 were made into a vulcanized rubber sheet with 6 mm thickness by a hot press machine in a flat mold under the conditions of 120° C., 2 hours, and 30 kg/cm². In accordance with the ASTM E 285 Standard Testing Method, the test samples were ablated with a flame which was produced by the accurate flow of a gas mixture of acetylene and oxygen (the acetylene flow: 1.7 ft³/min; the oxygen flow: 2.4 ft³/min). The distance between the specimen face and the torch tip was set to be 25.00±0.3 mm and the angle between torch and specimen to be 90±30. The test data are listed in the following Table 6.

TABLE 6
Ablation resistance of EPDM rubber
insulations of the present invention

| Example | Decomposition rate (sec/mm) | Ablation rate (mm/sec) |
|---|---|---|
| 3 | 10.05 | 0.099 |
| 4 | 9.92 | 0.101 |
| 5 | 8.34 | 0.120 |
| 6 | 10.18 | 0.098 |
| 7 | 10.03 | 0.099 |

On the basis of the data listed in Table 6, it is readily apparent that the rubber insulations of the present invention exhibit an excellent resistance to ablation. The rubber insulations of the present invention are therefore suitable for use as an insulating material of the rocket motor case of a tactical missile.

The product of the Example 5 contains a relatively small dose (10 phr) of ammonium sulfate, while the product of the Example 3 contains a greater dose (20 phr) of ammonium sulfate. By comparison, a reduction in the dose of filler results in a decrease in tensile strength of the insulation, as well as an increase in elongation of the insulation. In addition, a reduction in the dose of ammonium sulfate results in a decrease in resistance of the insulation to ablation. The experimental data thus indicate the important role that ammonium sulfate plays in the ablative resistance of the insulation of the present invention.

The product of the Example 4 contains an unprocessed ammonium sulfate powder, while the product of the Example 3 contains a processed ammonium sulfate powder. By comparison, the physical properties of the insulation of these two examples are almost on a par with each other, with the numerical deviations being in the allowable range of the experimental error. Furthermore, the product of the Example 3 is almost equal in ablative resistance to the counterpart of the Example 4. The experimental data demonstrate that the use of the method of the present invention to encapsulate a hydrophilic filler is effective, workable, and valid.

By comparing the physical properties of the products of the Examples 3 and 6, it becomes obvious that a greater dose of polyaramide fiber (20 phr) results in an increase in resistance of the insulation to ablation. However, the product of Example 6 exhibits an increase in tensile strength and a reduction in elongation, thereby suggesting the pros and the cons of the products of Example 6 in terms of application of the insulation.

The product of the Example 7 contains a halogenated fire retardant agent (30 phr) in place of ammonium sulfate (20 phr) of the product of the Example 3. However, the recipes of both Examples 3 and 7 contains antimony oxide (10 phr). The experimental data demonstrate that the products of both recipes exhibit corresponding resistance to ablation, and that ammonium sulfate is superior to the halogenated fire retardant agent in terms of a less amount of ammonium sulfate being used.

The Examples of the present invention described above are to be regarded in all respects as being illustrative and nonrestrictive. Accordingly, the present invention may be embodied in other specific forms without deviating from the spirit thereof. The present invention is therefore to be limited only by the scopes of the following claims.

1. A rocket motor insulation composition comprising:
(a) 50-95 parts by weight of a solid EPDM rubber, wherein said EPDM rubber represents ethylene propylene diene monomer rubber;
(b) 5-50 parts by weight of a liquid EPDM rubber whereby the weight parts of said liquid EPDM rubber and said solid EPDM rubber amount to 100 weight parts;
(c) 5-50 phr of polyaramide fiber, wherein phr represents parts by weight per 100 parts by weight of said solid EPDM rubber and said liquid EPDM rubber; and
(d) 5-50 phr of ammonium sulfate powder, wherein particles of said ammonium sulfate powder are encapsulated by a macromolecular rubber material to inhibit hydrophilic property of the particles.

2. The insulation composition as defined in claim 1 further comprising 5-100 phr of an inorganic filler, wherein said inorganic filler is silicon dioxide, aluminum hydroxide, or magnesium hydroxide.

3. The insulation composition as defined in claim 2 further comprising 4-8 phr of polyterpene resin as a tackifier.

4. The insulation composition as defined in claim 1 further comprising 0.1-5 phr of sulfur and 0.01-3 phr of a vulcanization accelerator, wherein said vulcanization accelerator is 4,4′-dithiodimorpholine, or N-tert-butyl-2-benzothiazole sulfenamide.

5. The insulation composition as defined in claim 1 comprising 55-80 parts by weight of said solid EPDM rubber and 20-45 parts by weight of said liquid EPDM rubber.

6. The insulation composition as defined in claim 1 comprising 10-30 phr of said polyaramide fiber.

7. The insulation composition as defined in claim 1 comprising 1-30 phr of said ammonium sulfate powder.

8. The insulation composition as defined in claim 1, wherein said macromolecular rubber material is polyurethane.

9. The insulation composition as defined in claim 1, wherein the particles of said ammonium sulfate powder have a diameter ranging from 50 micron to 80 micron.
